(19) United States
(12) Patent Application Publication
(10) Pub. No.: US 2025/0251294 A1
(43) Pub. Date: Aug. 7, 2025

(54) PRESSURE SENSING CUP WITH INTEGRAL MEMBRANE

(71) Applicant: Repligen Corporation, Waltham, MA (US)

(72) Inventors: Steven Cates, Washoe Valley, NV (US); Scott Bendon, Wales (GB); Stephen Murphy, Foulksmills (IE); Arun Thavarool, Waltham, MA (US)

(73) Assignee: Repligen Corporation, Waltham, MA (US)

(21) Appl. No.: 19/041,012

(22) Filed: Jan. 30, 2025

Related U.S. Application Data
(60) Provisional application No. 63/548,619, filed on Feb. 1, 2024.

(51) Int. Cl. G01L 19/00

(52) U.S. Cl. CPC G01L 19/0023; G01L 19/0038

(57) ABSTRACT

A tubing assembly includes first and second tubing segments, and a pressure cup portion formed between the first and second tubing segments. The pressure cup portion has a first open lateral side, and a second closed lateral side including a flat membrane member configured to engage a diaphragm of a pressure transmitter to transmit a pressure of a fluid disposed within the pressure cup portion to said diaphragm. The flat membrane member is integrally formed with the pressure cup portion. A mold for forming the tubing assembly, and a pressure sensing system includes the tubing assembly, a housing portion, and a pressure sensor receivable within the housing to position a diaphragm of the pressure sensor directly adjacent to the flat membrane member of the tubing assembly.

### CROSS-REFERENCE TO RELATED APPLICATIONS

This is a nonprovisional of pending U.S. provisional patent application Ser. No. 63/548,619, filed Feb. 1, 2024, the entirety of which application is incorporated by reference herein.

### FIELD

The present disclosure relates generally to the field of tubing assemblies. More particularly, the present disclosure relates to devices, systems, and methods for tubing assemblies that incorporate features for enhancing the integration of sensors for monitoring one or more states of fluids contained in or passing through such tubing assemblies. The present disclosure may particularly relate to devices, systems, and methods for using such tubing assemblies in pharmaceutical, biopharmaceutical, biotechnological, bioprocess, food, or beverage use or applications.

### BACKGROUND

Many commercial products are produced using chemical as well as biological processes. Pharmaceuticals, for example, are produced in commercial quantities using scaled-up reactors and other equipment. So-called biologics are drugs or other compounds that are produced or isolated from living entities such as cells or tissue. Biologics can be composed of proteins, nucleic acids, or complex combinations of these substances, and may even include living entities such as cells. In order to produce biologics on a commercial scale, sophisticated and expensive equipment is needed. In both pharmaceutical and biologics, for example, various processes need to occur before the final product is obtained. For example, in the case of biologics, cells may be grown in a chamber or vessel, such as a bioreactor or the like, and nutrients may need to be carefully modulated into the chamber or vessel. Waste products produced by cells may also have to be removed on a controlled basis from the chamber or vessel. As another example, biologic products produced by living cells or other organisms may need to be extracted and concentrated. This process may involve a variety of filtration and separation techniques.

Because there are a number of individual processes required to produce the final product, various reactants, solutions, and washes are often pumped or otherwise transported to various subsystems using conduits and associated valves. These systems may be quite cumbersome and organizationally complex due to the large numbers of conduits, valves, sensors, and the like that may be needed in such systems. Not only are these systems visually complex (e.g., with various pathways crossing one another), but they also include many components that are required to be sterilized between uses to avoid cross-contamination issues. Indeed, in the case of drug and biologic preparation, the Federal Food and Drug Administration (FDA) imposes strict requirements with regard to cleaning, sterilization, or bio-burden reduction procedures that are required for drug and pharmaceutical preparations. This is particularly a concern because many of these products are produced in batches which would require repeated cleaning, sterilization, or bio-burden reduction activities on a variety of components.

During the manufacturing process of pharmaceuticals and biologics there often is a need to incorporate sensors into the manufacturing process so that process variables are monitored. For example, the process variables that need to be monitored may include temperature, pressure, pH, conductivity, and the like. In conventional setups, sensors are placed directly along one or more points of the production process whereby the sensors themselves are inserted into the production stream where the sensor makes direct contact with the reactant or product stream. In conventional manufacturing processes, the sensors may need to be changed, for example, due to a malfunction or because the product being manufactured requires a different sensor. In these examples, it can be a time consuming and expensive process to replace these sensors and also ensuring that reactants or products remain uncontaminated.

It is with respect to these and other considerations that the present improvements may be useful.

### SUMMARY

This summary of the disclosure is given to aid understanding, and one of skill in the art will understand that each of the various aspects and features of the disclosure may advantageously be used separately in some instances, or in combination with other aspects and features of the disclosure in other instances. No limitation as to the scope of the claimed subject matter is intended by either the inclusion or non-inclusion of elements, components, or the like in this summary.

A tubing assembly is disclosed including a first tubing segment, a second tubing segment, and a pressure cup portion formed between said first tubing segment and said second tubing segment. In some embodiments the pressure cup portion has a first open lateral side, and a second closed lateral side comprising a flat membrane member configured to engage a diaphragm of a pressure transmitter to transmit a pressure of a fluid disposed within the pressure cup portion to said diaphragm, where the flat membrane member is integrally formed with the pressure cup portion.

The first tubing segment, said second tubing segment, and the pressure cup portion can be integrally formed as a single piece. A plug can be disposed within the first open lateral side of the pressure cup portion to seal the pressure cup portion. The first tubing segment, said second tubing segment, and said pressure cup portion are formed as a single piece via injection molding. The plug can have a shoulder that is received by a top surface of the first open lateral side of the pressure cup portion. The plug can be sealed against said shoulder using an adhesive. The first tubing segment, said second tubing segment, and the pressure cup portion with said plug engaged thereto, all may have a substantially similar inner diameter. The plug may have a U-shaped inner surface that conforms to and corresponds to the inner diameter of the first and second tubing segments when the plug is engaged with the pressure cup portion. The membrane may have a thickness of about 1/32-inch.

A mold for forming a tubing assembly includes a first molding half and a second molding half, where each of the first molding half and the second molding half includes a first tubing segment region, a second tubing segment region, and a pressure cup region between said first tubing segment region and said second tubing segment region. A mandrel is receivable between the first and second molding halves, the mandrel having a first portion receivable within the first tubing segment region, a second portion receivable within the second tubing segment region, and a third portion receivable within the pressure cup region. The third portion can include a flat upper surface positionable a predetermined distance from associated flat surfaces of the first and second molding halves, the predetermined distance corresponding to a thickness of a membrane portion of the tubing assembly.

The first and second portions of the mandrel are threadably received in threaded recesses of the third portion. The third portion of the mandrel is cylindrical and is sized to form an inner diameter of a pressure cup portion of the tubing assembly. Each of the first molding half and the second molding half further includes a nozzle seating configured to hold an injection nozzle in place to inject flowable material for forming the first and second tubing segments and the pressure cup portion including the membrane portion.

A pressure sensing system includes a tubing assembly having a first tubing segment, a second tubing segment, and a pressure cup portion formed between said first tubing segment and said second tubing segment. The pressure cup portion has a first open lateral side, and a second closed lateral side including a flat membrane member integrally formed with the pressure cup portion. A housing portion includes first and second housing sections for receiving a portion of the tubing assembly therein, one of the first and second housing sections having a recess disposed directly adjacent to the flat membrane member of the tubing assembly when the tubing assembly is received within the housing portion. A pressure sensor is receivable within the recess to position a diaphragm of the pressure sensor directly adjacent to the flat membrane member of the tubing assembly.

These and other features and advantages of the present disclosure, will be readily apparent from the following detailed description, the scope of the claimed invention being set out in the appended claims. While the following disclosure is presented in terms of aspects or embodiments, it should be appreciated that individual aspects can be claimed separately or in combination with aspects and features of that embodiment or any other embodiment.

### BRIEF DESCRIPTION OF THE DRAWINGS

Non-limiting embodiments of the present disclosure are described by way of example with reference to the accompanying drawings, which are schematic and not intended to be drawn to scale. The accompanying drawings are provided for purposes of illustration only, and the dimensions, positions, order, and relative sizes reflected in the figures in the drawings may vary. For example, devices may be enlarged so that detail is. In the figures, identical or nearly identical or equivalent elements are typically represented by the same reference characters, and similar elements are typically designated with similar reference numbers differing in increments of 100, with redundant description omitted. For purposes of clarity and simplicity, not every element is labeled in every figure, nor is every element of each embodiment shown where illustration is not necessary to allow those of ordinary skill in the art to understand the disclosure.

The detailed description will be better understood in conjunction with the accompanying drawings, wherein like reference characters represent like elements, as follows:

FIGS. 1A-1D are isometric, top plan, side, and cross-section views of the disclosed tubing assembly.

FIGS. 2A and 2B are isometric views of a pressure cup with integral membrane portion of the tube assembly of FIGS. 1A-1D.

FIG. 3 is a reverse isometric view of the pressure cup with integral membrane portion of FIGS. 1A-1D.

FIG. 4 are several cross-section views of the pressure cup with integral membrane portion of FIGS. 1A-1D taken along line 4-4 of FIG. 1C.

FIG. 5 shows a plurality of tubing assemblies in accordance with FIGS. 1A-1D overmolded with braided tubing segments.

FIGS. 6A and 6B are isometric views of a mold assembly for manufacturing the pressure cup with integral membrane portion of FIGS. 2A and 2B.

FIGS. 7A-7E are perspective, side, top, cross section, and detail, views of a pressure sensor and housing for use with the tubing assembly of FIGS. 1A-1D.

FIG. 8 shows an operating system for use with the tubing assembly of FIGS. 1A-1D.

### DETAILED DESCRIPTION

The following detailed description should be read with reference to the drawings, which depict illustrative embodiments. It is to be understood that the disclosure is not limited to the particular embodiments described, as such may vary. All apparatuses and systems and methods discussed herein are examples of apparatuses and/or systems and/or methods implemented in accordance with one or more principles of this disclosure. Each example of an embodiment is provided by way of explanation and is not the only way to implement these principles but are merely examples. Thus, references to elements or structures or features in the drawings must be appreciated as references to examples of embodiments of the disclosure, and should not be understood as limiting the disclosure to the specific elements, structures, or features illustrated. Other examples of manners of implementing the disclosed principles will occur to a person of ordinary skill in the art upon reading this disclosure. In fact, it will be apparent to those skilled in the art that various modifications and variations can be made in the present disclosure without departing from the scope or spirit of the present subject matter. For instance, features illustrated or described as part of one embodiment can be used with another embodiment to yield a still further embodiment. Thus, it is intended that the present subject matter covers such modifications and variations as come within the scope of the appended claims and their equivalents.

It will be appreciated that the present disclosure is set forth in various levels of detail in this application. In certain instances, details that are not necessary for one of ordinary skill in the art to understand the disclosure, or that render other details difficult to perceive may have been omitted. The terminology used herein is for the purpose of describing particular embodiments only, and is not intended to be limiting beyond the scope of the appended claims. Unless defined otherwise, technical terms used herein are to be understood as commonly understood by one of ordinary skill in the art to which the disclosure belongs. For instance, as used herein, a “free end” of an element is a terminal end at which such element does not extend beyond. As used herein, an “internal passage” or “internal passageway” or “bore” is not limited to a circular cross-section. It will be appreciated that all of the devices and/or methods disclosed and claimed herein can be made and executed without undue experimentation in light of the present disclosure.

In accordance with various principles of the present disclosure, a tubing assembly is formed in a manner which, among various other benefits, provides a pressure cup portion with an integral membrane that fits against the diaphragm of an appropriate pressure sensor such that the pressure of fluid within the tubing assembly can be read by the pressure sensor without any portion of the pressure sensor being directly exposed to the system fluid. This reduces the number of different materials for the finished tubing assembly product and/or simplifies the manufacturing process. The tubing assembly is formed in accordance with various principles of the present disclosure by molding (e.g., injection molding) a material (e.g., liquid silicone rubber) to form the tubing assembly, including the pressure cup portion and the integral membrane, as a single piece. The material from which the tubing assembly is formed may be sterilizable (such as by gamma irradiation) and generally otherwise suitable for sterile processes. The tubing assembly may be intended for single use and thus considered disposable.

Various embodiments of tubing assemblies, and associated systems and methods of forming such tubing assemblies and associated systems, will now be described with reference to examples illustrated in the accompanying drawings. Reference in this specification to “one embodiment,” “an embodiment,” “some embodiments”, “other embodiments”, etc. indicates that one or more particular features, structures, and/or characteristics in accordance with principles of the present disclosure may be included in connection with the embodiment. However, such references do not necessarily mean that all embodiments include the particular features, structures, and/or characteristics, or that an embodiment includes all features, structures, and/or characteristics. Some embodiments may include one or more such features, structures, and/or characteristics, in various combinations thereof. Moreover, references to “one embodiment,” “an embodiment,” “some embodiments”, “other embodiments”, etc. in various places in the specification are not necessarily all referring to the same embodiment, nor are separate or alternative embodiments necessarily mutually exclusive of other embodiments. When particular features, structures, and/or characteristics are described in connection with one embodiment, it should be understood that such features, structures, and/or characteristics may also be used in connection with other embodiments whether or not explicitly described, unless clearly stated to the contrary. It should further be understood that such features, structures, and/or characteristics may be used or present singly or in various combinations with one another to create alternative embodiments which are considered part of the present disclosure, as it would be too cumbersome to describe all of the numerous possible combinations and sub-combinations of features, structures, and/or characteristics. Moreover, various features, structures, and/or characteristics are described which may be exhibited by some embodiments and not by others. Similarly, various features, structures, and/or characteristics or requirements are described which may be features, structures, and/or characteristics or requirements for some embodiments but may not be features, structures, and/or characteristics or requirements for other embodiments. Therefore, the present disclosure is not limited to only the embodiments specifically described herein, and the examples of embodiments disclosed herein are not intended as limiting the broader aspects of the present disclosure.

It will be appreciated that common features in the drawings are identified by common reference elements and, for the sake of brevity and convenience, and without intent to limit, the descriptions of the common features are generally not repeated. For purposes of clarity, not all components having the same reference number are numbered. Moreover, a group of similar elements may be indicated by a number and letter, and reference may be made generally to one or such elements or such elements as a group by the number alone (without including the letters associated with each similar element). It will be appreciated that, in the following description, elements or components similar among the various illustrated embodiments with reference numbers are generally designated with the same reference numbers increased by a multiple of 1000, and redundant description is generally omitted for the sake of brevity. Moreover, certain features in one embodiment may be used across different embodiments and are not necessarily individually labeled when appearing in different embodiments.

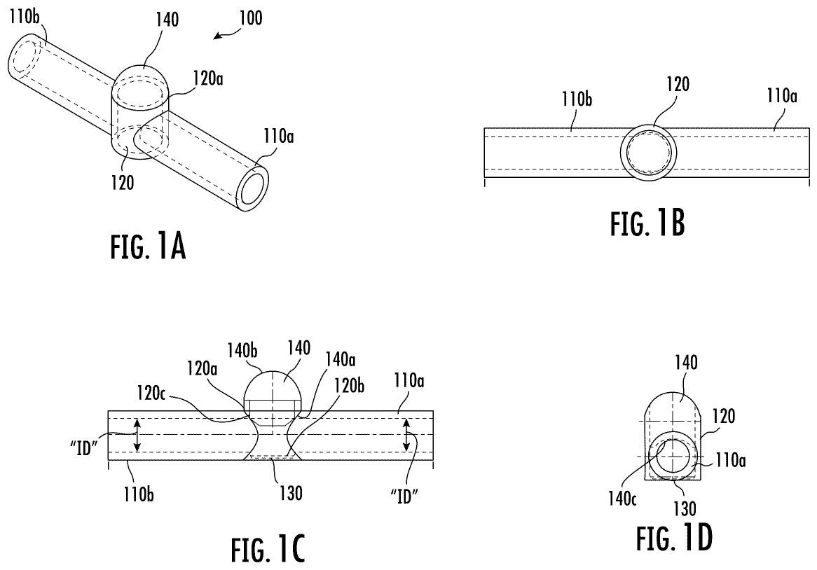

Turning now to the drawings, FIGS. 1A-D illustrate an example of a tubing assembly 100 formed in accordance with various principles of the present disclosure. The tubing assembly 100 includes a first tubing segment 110a, a second tubing segment 110b, and a pressure cup portion 120 disposed therebetween. The pressure cup portion 120 may be generally cylindrical and may have a first open lateral side 120a and a second closed lateral side 120b. The second closed lateral side may comprise an integrally formed membrane member 130, which in the illustrated embodiment has a circular shape corresponding to the cylindrical shape of the pressure cup portion 120. A plug 140 may be disposed within the first open lateral side of the pressure cup portion 120 to seal the pressure cup portion. In some embodiments the plug 140 has a shoulder portion 140a that is received by a top surface 120c of the pressure cup portion 120. The plug 140 may be sealed to the pressure cup portion 120 by an adhesive, heat welding, or the like.

In the illustrated embodiment the plug 140 has a rounded upper surface 140b and a U-shaped lower surface 140c. The U-shaped lower surface 140c may be sized to conform to and correspond with the inner diameter “ID” of the first and second tubing segments when the plug 140 is engaged with the pressure cup portion 120. Alternative shapes from the upper and lower surfaces 140b, 140c are contemplated.

In some embodiments the membrane member 130 may have a thickness “T” of from 0.028″ to 0.032″. In example embodiments the membrane member 130 may have a thickness “T” of 1/32-inch. The pressure cup portion 120 may have an inner diameter that is substantially the same as the inner diameter “ID” of the associated first and second tubing segments 110a, 110b, although this is not critical. The pressure cup portion is specifically designed (ID×H) to minimize product hold-up during product recovery steps of a bioprocessing method. The ID of the associated first and second tubing segments (110a, 110b) can range from between ⅛″ to ¾″ depending upon the process requirements.

In non-limiting example embodiments the first and second tubing segments 110a, 110b, pressure cup portion 120, and membrane member 130 may be injection molded as a single piece to reduce the total number of materials exposed to system fluid and also to enhance the robustness of the tubing assembly 100. The molding conditions may be selected or set and/or the mold may be formed in accordance with various principles of the present disclosure to achieve the desired finished configuration of the tubing assembly 100.

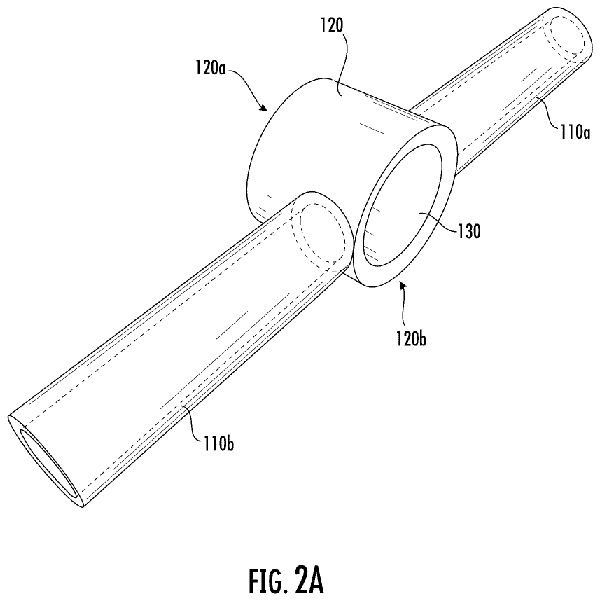

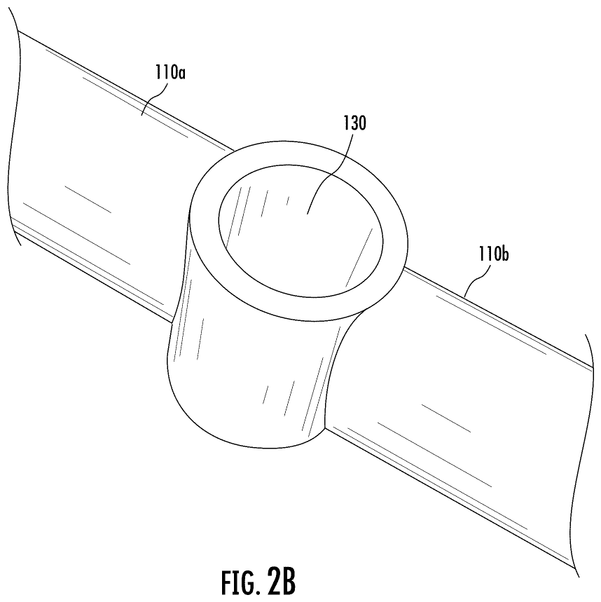

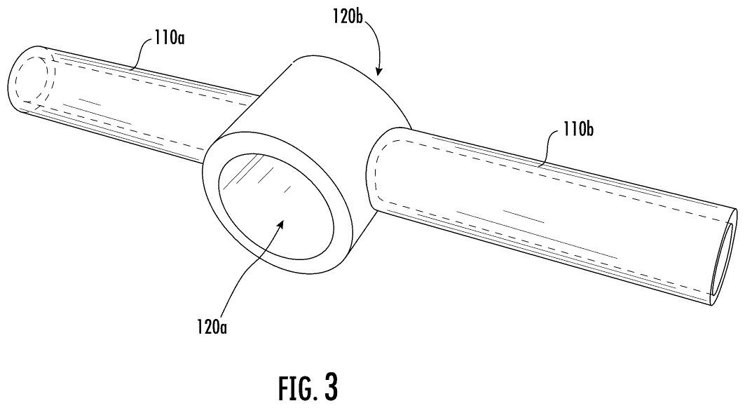

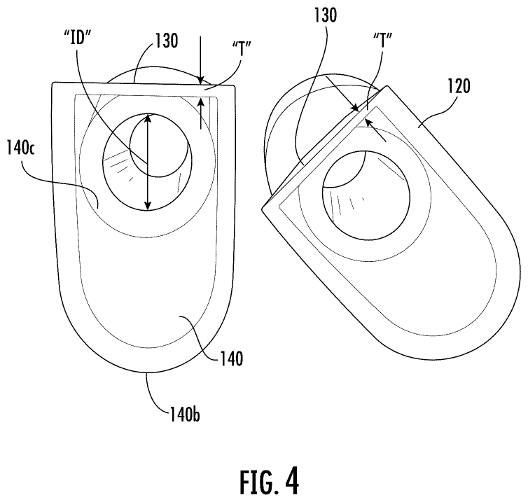

FIGS. 2A, 2B and 3 illustrate the tubing assembly 100 including first and second tubing segments 110a, 110b, pressure cup portion 120 having first open lateral side 120a, second closed lateral side 120b, and membrane member 130. FIG. 4 is a cross section view of the tubing assembly 100 taken along line 4-4 of FIG. 1A. As can be seen, the plug 140 is engaged with the pressure cup portion 120. As previously mentioned, the U-shaped lower surface 140c is sized to conform to and correspond with the inner diameter “ID” of the first and second tubing segments 110a, 110b when the plug 140 is engaged with the pressure cup portion 120. The membrane 130 is visible with thickness “T”, and the rounded upper surface 140b can be seen.

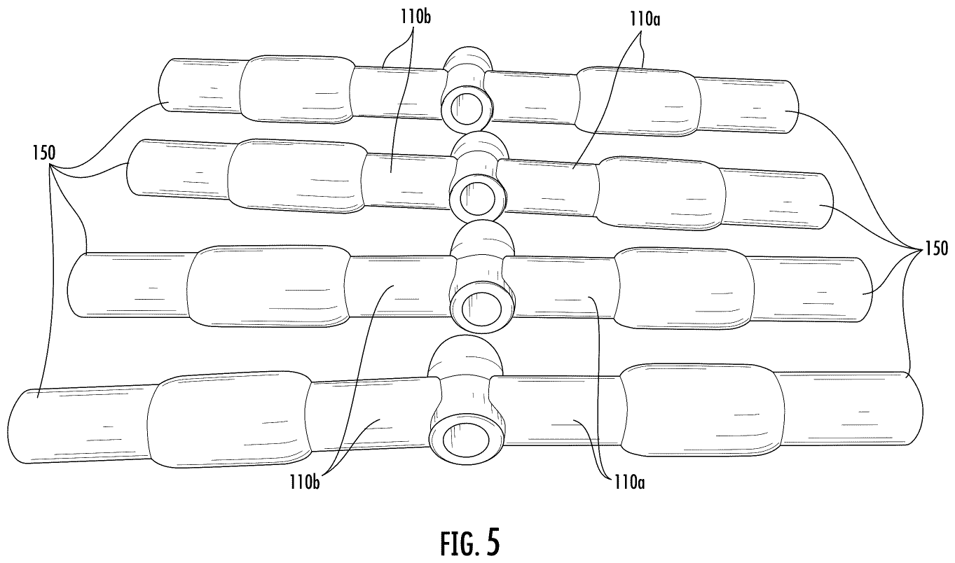

FIG. 5 shows a plurality of tubing assemblies 100 according to the disclosure overmolded with braided tubing elements 150 used with typical flow path assemblies for systems in which the tubing assemblies will be employed.

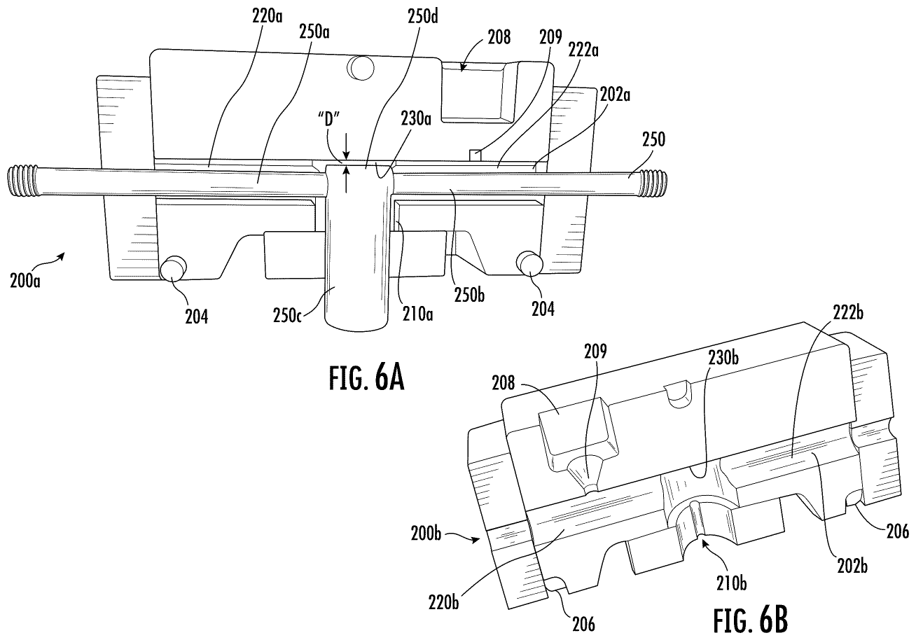

Referring now to FIGS. 6A and 6B, an example of a mold 200 which may be used to form a tubing assembly 100 in accordance with various principles of the present disclosure. The mold 200 may be formed of mating mold halves 200a, 200b, each defining a molding cavity 202a, 202b sized, shaped, configured, and/or dimensioned to form a tubing assembly 100 in accordance with various principles of the present disclosure. The mold halves 200a, 200b may include alignment elements 204, 206 configured to align the mold halves 200a, 200b with respect to each other. For instance, in the example of an embodiment illustrated in FIGS. 6A and 6B, a female alignment element 204 may be provided on one mold half 200a, and a male alignment element 206 may be provided on the other mold half 200b, the alignment elements 204, 206 being sized, shaped, configured, and/or dimensioned to mate with each other to hold the mold halves 200a, 200b with respect to each other so that the mold halves 200a, 200b are properly aligned to form the first and second tubing segments 110a, 110b, pressure cup portion 120, and membrane member 130.

A pressure cup region 210a, 210b within each molding cavity 202a, 202b is specifically sized, shaped, configured, and/or dimensioned for forming a pressure cup portion 120, with an integral membrane member 130 within the mold 200 in accordance with various principles of the present disclosure. First and second tubing segment regions 220a, 220b; 222a, 222b formed within each molding cavity 202a, 202b are specifically sized, shaped, configured, and/or dimensioned for forming the first and second tubing segments 110a, 110b on opposite sides of the pressure cup portion 120 to form a tubing assembly 100 in accordance with various principles of the present disclosure.

In some embodiments, as illustrated in FIG. 6A, a mandrel 250 may be disposed within the molding cavities 202a, 202b to facilitate formation of the tubing assembly 100 via injection molding process. The mandrel 250 can have a first portion 250a receivable within the first tubing segment regions 220a, 220b, a second portion 250b receivable within the second tubing segment regions 222a, 222b, and a third portion 250c receivable within the pressure cup regions 210a, 210b.

The third portion 250c may have a flat upper surface 250d positionable a predetermined distance “D” from opposing flat surfaces 230a, 230b of the first and second molding halves 200a, 200b. In non-limiting example embodiments the predetermined distance “D” corresponds to a thickness “T” of the membrane portion 130 of the finished tubing assembly 100 (see FIG. 4). In some example embodiments the predetermined distance “D” is 0.035″ to accommodate nominal skrinkage. The insertion position of the pressure cup mandrel can be fixed by the attachment of the first and second portions 250a, 250b of the mandrel 250. The first and second portions 250a, 250b can be held in a fixed position by the external mold fixture endplates.

In some embodiments the first and second portions 250a, 250b of the mandrel 250 are threadably received in threaded recesses of the third portion 250c (not shown). The first and second portions 250a, 250b of the mandrel 250 are cylindrical and are sized to form the inner diameter “ID” of the first and second tubing segments 110a, 110b. The third portion 250c of the mandrel is also cylindrical and is sized to form the generally cylindrical pressure cup portion 120 of the tubing assembly 120.

In accordance with a non-limiting example aspect of the present disclosure, the tubing assembly 100 is formed by injection molding while the mold halves 200a, 200b are held together with mandrel 250 disposed therein. In one aspect, the injection molded material may be in a flowable form which is injected into the mold 200 in a heated state or at generally ambient temperature. Liquid silicone rubber, such as, in particular, a medical grade liquid silicone rubber, and even more particularly, a liquid silicone rubber (such as a medical grade liquid silicone rubber) with a 60 Shore A Durometer may advantageously be used, although the present disclosure need not be so limited. For the sake of convenience, and without intent to limit, reference may be made herein to liquid silicone rubber as the material from which tubing assembly may be formed in accordance with various principles of the present disclosure, although other materials may be used, the present disclosure not being limited by the particular material used to form a coupler with various of the properties and/or features disclosed herein. The mold halves 200a, 200b illustrated in FIGS. 6A-6B include a nozzle seating 208 configured to securely hold an injection nozzle (not shown, but which may be any nozzle known to those of ordinary skill in the art for injecting materials into a mold) to inject material through an injection port 209 to form a tubing assembly 100 within the aforementioned regions. The material from which the tubing assembly 100 is formed is then allowed to solidify and cool.

The mixing machine for the material from which the tubing assembly 100 is to be formed may be set to about 800-1000 psi (such as depending on various operating conditions and/or properties of the material being molded). The mold 200, and optionally also the mandrel 250 and a press or platen (not shown, but which may be any press or platen known to those of ordinary skill in the art for use in an injection molding process) holding the mold halves 200a, 200b together, are heated to cure the material. In some embodiments, a heat press is set to approximately 135-200° C. (approximately 275°-392° F. or 408.2-473.5 K) and the mold 200 and mandrel 250 are thereby heated (e.g., by heat conduction from the heat press). In some embodiments, the mold 200 and mandrel 250 are allowed to heat soak for approximately 15 minutes. The material is injected into the mold 200 at ambient temperature, and cured within the heated environment within the mold 200. The material is allowed to cure, such as for about 2-3 minutes, before being removed from the mold 200. If necessary or desired, the tubing assembly may be cooled for an additional amount of time outside the mold 200.

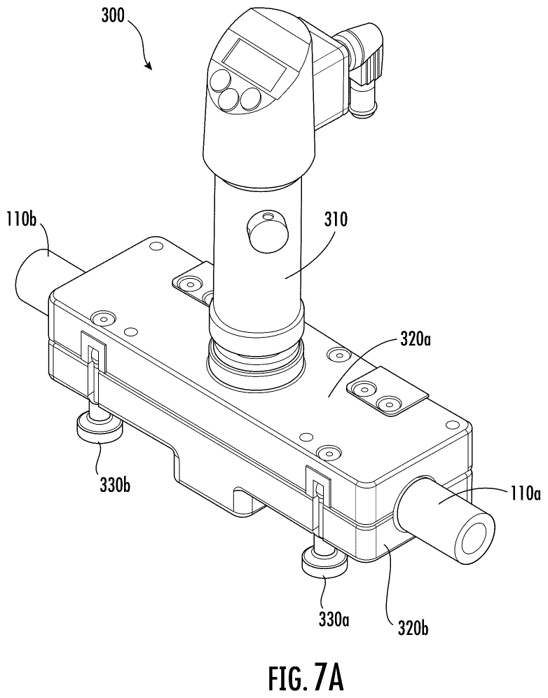

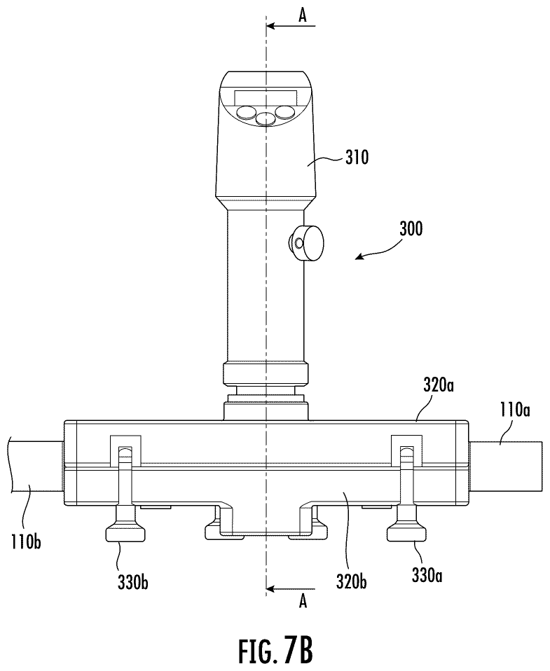

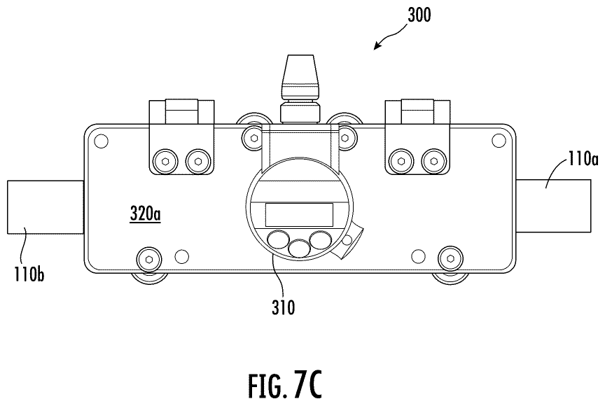

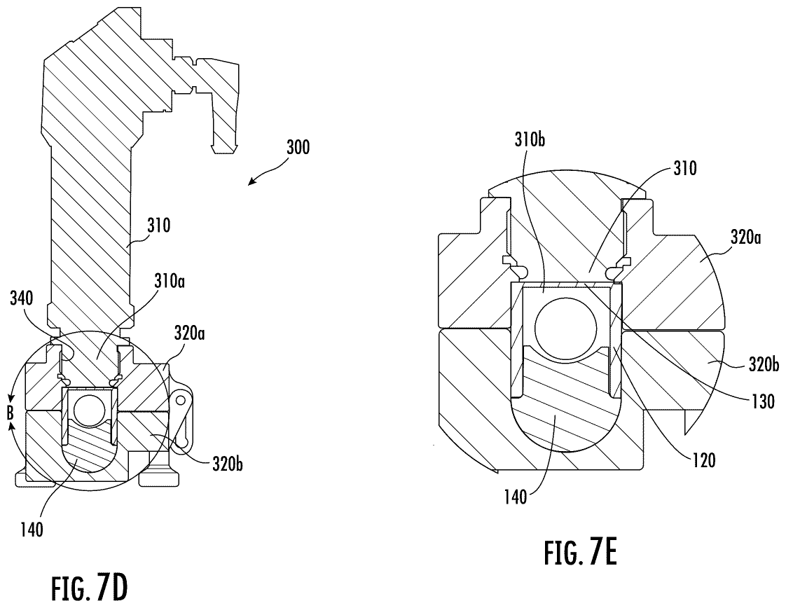

FIGS. 7A-7E illustrate various aspects of a pressure sensing system 300 in accordance with embodiments of the disclosure.

FIGS. 7A-C shows the pressure sensing system 300 including pressure sensor/transmitter 310, housing 320, and tubing assembly 100 disposed therein (with first and second tubing segments 110a, 110 extending from opposite sides of the housing). In the illustrated embodiment the housing 320 is formed by first and second housing halves 320a, 320b which are hingedly connected along a first common side of the housing halves and are fixed together via pivotable threaded fasteners 330a, 330b coupled to a second common side of the housing halves. A first end 310a of the pressure sensor/transmitter 310 is received within an opening 340 in the first housing half 320a (see FIG. 7D) so that a diaphragm portion 310b of the pressure sensor/transmitter 310 abuts the membrane 130 of the tubing assembly 110 (see FIG. 7E). In some non-limiting example embodiments the pressure sensor/transmitter 310 is an Endress+Hauser (P/N PTP33B), manufactured by Endress+Hauser, 2350 Endress Place, Greenwood, IN, 46143.

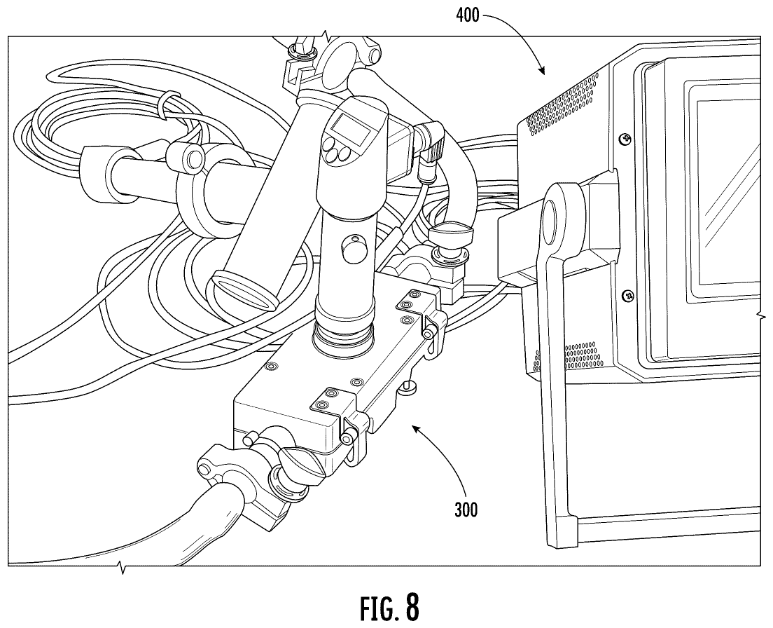

In operation, the membrane 130 of the tubing assembly 110 expands under system pressure to press against the diaphragm portion 310b of the pressure sensor/transmitter 310. The pressure sensor/transmitter 310 converts this pressure to a digital signal that is transmitted to an controller of an operating system 400 such as shown in FIG. 8. Monitoring of the pressure in the system can thus be achieved without any portion of the pressure sensor/transmitter 310 being exposed to the system fluid.

In view of the above, it should be understood that the various embodiments illustrated in the figures have several separate and independent features, which each, at least alone, has unique benefits which are desirable for, yet not critical to, the presently disclosed tubing assemblies, and methods and apparatus for forming such tubing assemblies. Therefore, the various separate features described herein need not all be present in order to achieve at least some of the desired characteristics and/or benefits described herein. One or more of the features described with reference to one embodiment can be combined with one or more of the features of any of the other embodiments provided herein. That is, any of the features described herein can be mixed and matched to create hybrid designs, and such hybrid designs are within the scope of the present disclosure. Therefore, the present invention is not limited to only the embodiments specifically described herein. The above descriptions are of illustrative examples of embodiments only, and are not intended as limiting the broader aspects of the present disclosure.

The foregoing discussion has broad application and has been presented for purposes of illustration and description and is not intended to limit the disclosure to the form or forms disclosed herein. It will be understood that various additions, modifications, and substitutions may be made to embodiments disclosed herein without departing from the concept, spirit, and scope of the present disclosure. In particular, it will be clear to those skilled in the art that principles of the present disclosure may be embodied in other forms, structures, arrangements, proportions, and with other elements, materials, and components, without departing from the concept, spirit, or scope, or characteristics thereof. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. While the disclosure is presented in terms of embodiments, it should be appreciated that the various separate features of the present subject matter need not all be present in order to achieve at least some of the desired characteristics and/or benefits of the present subject matter or such individual features. One skilled in the art will appreciate that the disclosure may be used with many modifications or modifications of structure, arrangement, proportions, materials, components, and otherwise, used in the practice of the disclosure, which are particularly adapted to specific environments and operative requirements without departing from the principles or spirit or scope of the present disclosure. For example, elements shown as integrally formed may be constructed of multiple parts or elements shown as multiple parts may be integrally formed, the operation of elements may be reversed or otherwise varied, the size or dimensions of the elements may be varied. Similarly, while operations or actions or procedures are described in a particular order, this should not be understood as requiring such particular order, or that all operations or actions or procedures are to be performed, to achieve desirable results. Additionally, other implementations are within the scope of the following claims. In some cases, the actions recited in the claims can be performed in a different order and still achieve desirable results. The presently disclosed embodiments are therefore to be considered in all respects as illustrative and not restrictive, the scope of the claimed subject matter being indicated by the appended claims, and not limited to the foregoing description or particular embodiments or arrangements described or illustrated herein. In view of the foregoing, individual features of any embodiment may be used and can be claimed separately or in combination with features of that embodiment or any other embodiment, the scope of the subject matter being indicated by the appended claims, and not limited to the foregoing description.

In the foregoing description and the following claims, the following will be appreciated. The phrases “at least one”, “one or more”, and “and/or”, as used herein, are open-ended expressions that are both conjunctive and disjunctive in operation. The terms “a”, “an”, “the”, “first”, “second”, etc., do not preclude a plurality. For example, the term “a” or “an” entity, as used herein, refers to one or more of that entity. As such, the terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, counterclockwise, and/or the like) are only used for identification purposes to aid the reader's understanding of the present disclosure, and/or serve to distinguish regions of the associated elements from one another, and do not limit the associated element, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another.

The following claims are hereby incorporated into this Detailed Description by this reference, with each claim standing on its own as a separate embodiment of the present disclosure. In the claims, the term “comprises/comprising” does not exclude the presence of other elements, components, features, regions, integers, steps, operations, etc. Additionally, although individual features may be included in different claims, these may possibly advantageously be combined, and the inclusion in different claims does not imply that a combination of features is not feasible and/or advantageous. In addition, singular references do not exclude a plurality. Reference signs in the claims are provided merely as a clarifying example and shall not be construed as limiting the scope of the claims in any way.

What is claimed is:

1. A tubing assembly comprising:
a first tubing segment;
a second tubing segment; and
a pressure cup portion formed between said first tubing segment and said second tubing segment;
wherein said pressure cup portion has a first open lateral side, and a second closed lateral side comprising a flat membrane member configured to engage a diaphragm of a pressure transmitter to transmit a pressure of a fluid disposed within the pressure cup portion to said diaphragm, and
wherein the flat membrane member is integrally formed with the pressure cup portion.

2. The tubing assembly of claim 1, wherein said first tubing segment, said second tubing segment, and said pressure cup portion are integrally formed as a single piece.

3. The tubing assembly of claim 1, further comprising a plug disposed within the first open lateral side of the pressure cup portion to seal the pressure cup portion.

4. The tubing assembly of claim 3, wherein said first tubing segment, said second tubing segment, and said pressure cup portion are formed as a single piece via injection molding.

5. The tubing assembly of claim 1, wherein the plug has a shoulder that is received by a top surface of the first open lateral side of the pressure cup portion.

6. The tubing assembly of claim 5, wherein the plug is sealed against said shoulder using an adhesive.

7. The tubing assembly of claim 1, wherein said first tubing segment, said second tubing segment, and said pressure cup portion with said plug engaged thereto, all have a substantially similar inner diameter.

8. The tubing assembly of claim 7, wherein the plug has a U-shaped inner surface that conforms to and corresponds to the inner diameter of the first and second tubing segments when the plug is engaged with the pressure cup portion.

9. The tubing assembly of claim 7, wherein the membrane has a thickness of about 1/32-inch.

10. A mold for forming a tubing assembly, said mold comprising:
a first molding half; and
a second molding half;
wherein each of said first molding half and said second molding half comprises a first tubing segment region, a second tubing segment region, and a pressure cup region between said first tubing segment region and said second tubing segment region, and
a mandrel receivable between the first and second molding halves, the mandrel having a first portion receivable within the first tubing segment region, a second portion receivable within the second tubing segment region, and a third portion receivable within the pressure cup region, the third portion having a flat upper surface positionable a predetermined distance from associated flat surfaces of the first and second molding halves, the predetermined distance corresponding to a thickness of a membrane portion of the tubing assembly.

11. The mold of claim 10, wherein the first and second portions of the mandrel are threadably received in threaded recesses of the third portion.

12. The mold of claim 10, wherein the third portion of the mandrel is cylindrical and is sized to form an inner diameter of a pressure cup portion of the tubing assembly.

13. The mold of claim 10, wherein each of said first molding half and said second molding half further comprises a nozzle seating configured to hold an injection nozzle in place to inject flowable material for forming the first and second tubing segments and the pressure cup portion including the membrane portion.

14. A pressure sensing system comprising:
a tubing assembly comprising a first tubing segment, a second tubing segment, and a pressure cup portion formed between said first tubing segment and said second tubing segment; the pressure cup portion having a first open lateral side, and a second closed lateral side comprising a flat membrane member, the flat membrane member integrally formed with the pressure cup portion;
a housing portion comprising first and second housing sections for receiving a portion of the tubing assembly therein, one of the first and second housing sections having a recess disposed directly adjacent to the flat membrane member of the tubing assembly when the tubing assembly is received within the housing portion; and
a pressure sensor receivable within the recess to position a diaphragm of the pressure sensor directly adjacent to the flat membrane member of the tubing assembly.
